(19) United States
(12) Patent Application Publication
(10) Pub. No.: US 2022/0299426 A1
(43) Pub. Date: Sep. 22, 2022

(54) HINGED CUVETTE WITH ELECTROMAGNETIC BLOCKING

(71) Applicant: TELLSPEC, LTD., London (GB)

(72) Inventors: Isabel De Oliveira Correa, London (GB); Diogo Barros Gonçalves, London (GB); Paolo Satta, London (GB); Massimiliano Datti, London (GB); Alessandro Spalletta, London (GB)

(73) Assignee: TELLSPEC, LTD., London (GB)

(21) Appl. No.: 17/208,884

(22) Filed: Mar. 22, 2021

(51) Int. Cl. G01N 21/03

(52) U.S. Cl. CPC G01N 21/0303; G01N 2021/0389; G01N 2021/0375

(57) ABSTRACT

A cuvette includes a first body portion and a second body portion. The first body portion and the second body portion may be connected by a hinge. The cuvette may include a first slide and a second slide.

### TECHNICAL FIELD

The present disclosure relates to a hinged cuvette used in spectrographic sampling of liquids.

### BACKGROUND

Development of the microscope was a major step forward in the process of human innovation because the microscope opened a portion of the world to human understanding that humans, for the most part, did not even know existed. The advent of microscopes, however, required a way to secure a specimen to be examined in a manner that allowed a user to view the specimen without losing focus or having the small specimen move from outside of a view of a lens of a microscope. To solve this problem, slides were developed which were intended to hold a specimen on a platform connected to a microscope. These slides were typically made of flat and relatively thin slabs of glass that could either hold a sample on the surface of the slide by water tension, for example, or, alternatively, be sandwiched between two slides positioned parallel to each other. Glass provided the ability for light to penetrate a sample from underneath and further illuminate the sample under the microscope.

Eventually, spectroscopes and spectrographs were developed to determine the type and contents of a particular sample, which initially was typically in the field of minerals and mining, particularly for gold. For example, in examining a sample of malachite, a spectrograph may indicate that copper is the main periodic element of the sample, but also includes lower percentages of carbon, oxygen, and hydrogen to form copper carbonate hydroxide. Spectroscopy made it possible to determine a percentage of a particular mineral, such as gold, in an unmined sample of minerals. Samples were typically placed on slides and exposed to various wavelengths of light along the electromagnetic spectrum to determine the reflectivity of light from the sample, which could then be compared to known reflectivity for each periodic element.

More recently, spectroscopes and spectrographs have improved to be useful in the field of determining the type and contents of liquid samples. However, conventional slides caused several problems when a particular sample is a liquid. First, a significant number of air bubbles are trapped between two glass slides with the liquid which can affect the accuracy of the perceived sample. Second, glass slides allowed the sample to leak out between the two glass slides as only the surface tension of the liquid sample maintains the liquid between the slides. Because of these issues, cuvettes were developed.

Conventional cuvettes are generally made in two forms. In one form, a cuvette is essentially a square vessel, made from glass, which contains liquid inside of it, much like a square glass cup. In some cases, these cuvettes can be made from quartz crystal instead of glass and include funnels which funnel the liquid into a narrow chamber near the bottom of the cuvette. The other form of cuvettes is typically formed as a metal device that is square in one cross section (e.g., a base) and rectangular in another cross section (e.g. a vertical). The cuvette extends vertical walls from a square base. These cuvettes have one or more spring steel clips that secure two glass slides together and typically against one of the vertical walls of the cuvette.

Both of these conventional cuvettes suffer from the same problems as the two glass slides. For example, the square glass cup style cuvettes also contain bubbles that can only be broken by contaminating the sample with a probe or another device to break the surface tension of the air bubbles. The metal cuvettes with spring steel clips succeed in holding two glass slides together, but still suffer from problems with air bubbles in the sample and allow the sample to leak from between the slides.

Accordingly, there is a need for a cuvette which prevents air bubbles from decreasing accuracy of a spectroscopic sample. There is a further need for a cuvette which prevents leaking while also preventing air bubbles from decreasing accuracy of a spectroscopic sample. It is therefore an object of this disclosure to provide a cuvette which prevents leaking and reduces or eliminates air bubble contamination in liquid samples for spectrographic analysis.

### SUMMARY OF THE DISCLOSURE

A cuvette includes a first body portion and a second body portion. The first body portion and the second body portion may be connected by a hinge. The cuvette may include a first slide and a second slide.

### BRIEF DESCRIPTION OF THE DRAWINGS

The following gives a detailed description of the specific embodiments of the disclosure, accompanied by diagrams to clarify the technical solutions of the embodiments and their benefits.

FIG. 1 illustrates an exploded view of a cuvette according to an embodiment of the present disclosure.

FIG. 2 illustrates a perspective view of a cuvette according to an embodiment of the present disclosure, in a closed position.

FIG. 3 illustrates a perspective view of a cuvette according to an embodiment of the present disclosure in a partially open condition.

FIG. 4 illustrates a perspective view of a cuvette according to an embodiment of the present disclosure in a fully open condition.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

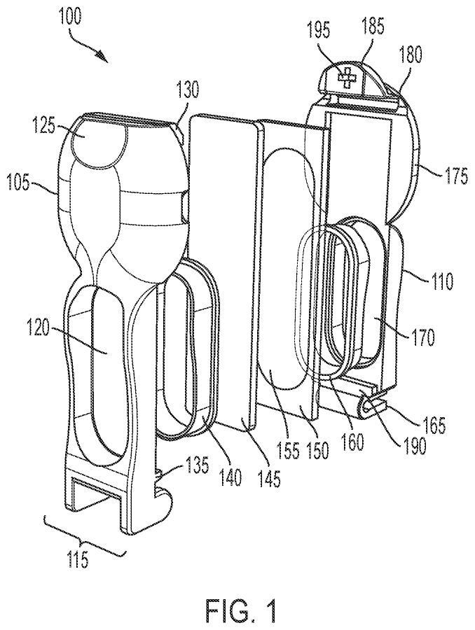

FIG. 1 illustrates an exploded view of a cuvette 100 according to an embodiment of the present disclosure. Cuvette 100 includes a first body portion 105 and a second body portion 110. First body portion 105 and second body portion 110 are generally, with exceptions, mirror shapes of each other, one constituting a front of cuvette 100 and the other constituting a back of cuvette 100. First body portion 105 includes a first hinge element 115, which couples with another element, such as a second hinge element 165 on second body portion 110 to form a hinge on cuvette 100, as will be described below. First hinge element 115 may be disposed at a bottom of cuvette 100, as shown in FIG. 1 although other implementations are possible. For example, corresponding hinge elements could be formed along respective sides of first body portion 105 and second body portion 110 such that a hinge is positioned parallel to a length of cuvette 100 instead of perpendicular to the length of cuvette 100, as shown in FIG. 1.

First body portion 105 may include a window 120 which accepts a first electromagnetic blocker 140, which will be described below, and which also lets light pass from outside of cuvette 100 into a first slide 145 and a second slide 150, which will be discussed below. Window 120 may take any shape, although a generally oval shape is shown in FIG. 1. Generally speaking, window 120 is positioned in cuvette 100 to allow transmission of electromagnetic emissions through window 120 and into a liquid sample held in cuvette 100 for spectroscopy or spectrography of the liquid sample.

First body portion 105 may further include a finger recess 125 which abuts clip alignment element 130 to provide a user with an ergonomic interaction point for clipping and unclipping first body portion 105 from second body portion 110, as will further be discussed below. Finger recess 125 and clip alignment element 130 are but one side of a clip which can retain cuvette 100 in a closed position.

First body portion 105 further includes a first slide retainer 135, which may be implemented as a shelf with a thickness approximately equal to a slide along with a recess in the shape of the slide that lets the slide rest in the recess. For example, first slide 145 may be installed and sit on first slide retainer 135 and, optionally, within a recess provided in first slide retainer 135. The recess for first slide 145 may be optionally provided in first body portion 105 which accepts at least a portion of a thickness of a slide below a surface of first body portion 105 such that at least some material of first body portion 105 extends above a thickness of first slide 145. In one embodiment, first slide retainer 135 may be positioned to hold a first slide 145 higher than second slide retainer 190 on second body portion 110, as will be discussed below, for the purpose of eliminating or popping air bubbles trapped between first slide 145 and second slide 150.

As previously mentioned, first body portion 105 may include a first electromagnetic blocker 140. First electromagnetic blocker 140 may be installed within window 120 of cuvette 100 and serve to block undesirable electromagnetic emissions from penetrating the sample and ensuring that transmission losses of desirable electromagnetic emissions are minimized through window 120. In essence, first electromagnetic blocker 140 may act as a filter which discriminates out undesirable electromagnetic emissions while allowing desirable electromagnetic emissions to pass through unimpeded. For example, first electromagnetic blocker 140 may be a high absorbance material, which blocks out light emissions from outside the cuvette while allowing light provided into window 120 to pass through into first slide 145 and second slide 155. In one embodiment, first electromagnetic blocker 140 may be selected from a material that has a high absorbance of electromagnetic emissions in the non-visible portion of the electromagnetic spectrum, such as ultraviolet light, infrared light, x-rays, gamma rays, and other similar lights. In an embodiment, first electromagnetic blocker 140 may be selected from a material that has a high absorbance of electromagnetic emission in the visible and non-visible portion of the electromagnetic spectrum. In another embodiment, first electromagnetic blocker 140 may be selected from a material that has high absorbance of electromagnetic emission in the visible portion of the electromagnetic spectrum. In another embodiment, first electromagnetic blocker 140 may be selected from a material that has a high absorbance of electromagnetic emission to wavelengths of light used by a spectroscope or a spectrograph. In practice, first electromagnetic blocker 140 may be fully seated within window 120 such that first slide 145 may be installed on first slide retainer 135 in first body portion 105.

First slide 145 and second slide 150 may be made from glass, or more preferably, quartz, for optimal transmission of light through first slide 145 and second slide 150. First slide 145 and second slide 150 may be as close to the same size as possible in terms of length and width, although second slide 150 may include a convex portion 155. In one embodiment, convex portion 155 of second slide 150 may provide a section of second slide 150 that is deeper than first slide 145. Convex portion 155 is particularly suitable for containing and maintaining liquid samples between first slide 145 and second slide 150. When first slide 145 and second slide 150 are installed together, convex portion 155 provides a gap where liquid can be contained without leaking from between slides. In other words, first slide 145 provides direct contact, without sample material, between first slide 145 and second slide 150 at virtually all portions of second slide 150 with the exception of convex portion 155, which forms a pocket of sorts to hold and maintain a liquid sample between first slide 145 and second slide 150, when first body portion 105 and second body portion 110 are closed together such that cuvette 100 is disposed in a closed position, as will be further discussed below.

Second body portion 110 may further include a window whereby a second electromagnetic blocker 160 may be installed in a manner similar to that described above with respect to first electromagnetic blocker 140 being installed in window 120 of first body portion 110. Second electromagnetic blocker 160 may be similar in implementation and description to first electromagnetic blocker 140, as discussed above.

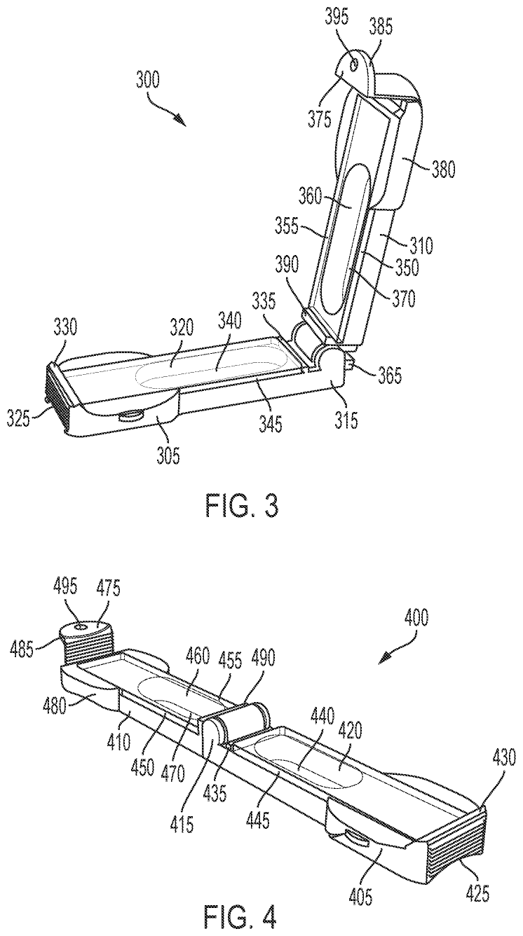

Second body portion 110 may further include a second hinge element 165 that may interact with first hinge element 115 on first body portion 110. Second hinge element 165 may, for example, include a male element of a hinge while first hinge element 115 may include a female element of a hinge, or vice versa. Further, the embodiment of cuvette 100 shown in FIG. 1 is not limited to positioning first hinge element 115 and second hinge element 165 in a manner that is perpendicular to a length of cuvette 100. First hinge element 115 and second hinge element 165 may be positioned along a length of cuvette 100, parallel to the length of cuvette 100 and allow cuvette 100 to open along a lengthwise axis instead of a widthwise axis, as shown in FIG. 1, FIG. 3, and FIG. 4, which will be discussed below.

Second body portion 110 further includes a second slide support 190 which includes a shelf having a thickness that is approximately equal to or less than the thickness of slide 150 and includes a recess which allows slide 150 to be supported by second body portion 110 and held in a specific place in the recess by second body portion 110. It is noted that first slide support 135 and second slide support 190 may be disposed at different positions relative to a length of cuvette 100. In one embodiment, first slide support 135 may be positioned to be higher than second slide support 190 in order to cause first slide 145 and second slide 150 to be offset from each other when cuvette 100 is in a closed position. As first slide 145 comes into contact with second slide 150 during closing of cuvette 100, first slide 145 slides along slide 150 which prevents formation of air bubbles in a liquid sample and tends to pop existing air bubbles within the sample to increase an accuracy of a spectroscopic or spectrographic analysis.

Second body portion 110 further includes clip alignment elements 175 and 180 which may interface with, for example, clip alignment element 130 on first body portion 105, for example, which serve to nudge first body portion 105 and second body portion 110 into alignment and proper connection by clip 185. Clip 185 may include a friction type connection or a mechanical interlock of several corresponding sawtooth ridges disposed oppositely of one another on first body portion 105 and second body portion 110 to form clip 185, for example. Clip 185 may further be implemented with clip alignment interface 130. As cuvette 100 is closed clip 185 may extend from second body portion 110 over first body portion 105 and clip by means of a tongue and groove joint, a friction joint, a mechanical interlock, or other joints known in the art to secure first body portion 105 to second body portion 110. Clip 185 may extend across first body portion 105 to finger recess 125 to allow a user to use finger recess 125 both for ensuring that cuvette 100 is closed and for providing a point of leverage to release a connection between clip 185 and first body portion 105, as desired. Cuvette 100 may therefore be opened and secured in a closed position to ensure that a liquid sample is maintained within cuvette 100 for spectroscopic or spectrographic analysis.

Second body portion 110 in cuvette 100 may further include a hole 195 which may be useful in hanging the cuvette by a wire during certain practical applications of examining a liquid sample.

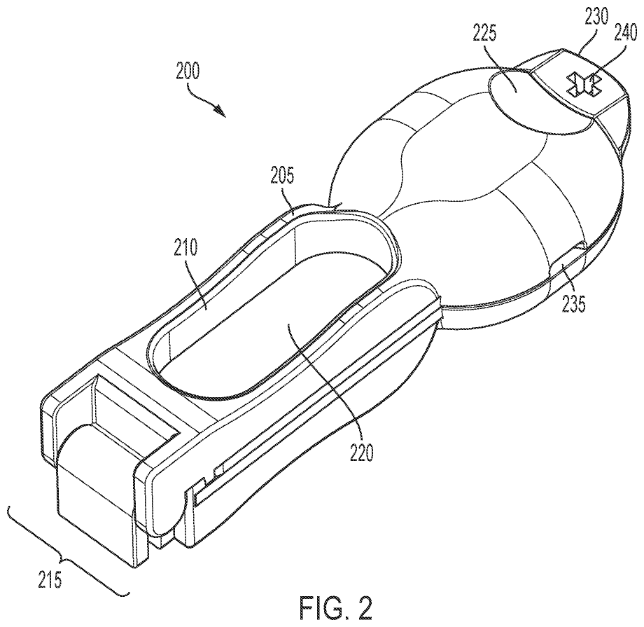

FIG. 2 illustrates a perspective view of a cuvette 200 according to an embodiment of the present disclosure in a closed position. Cuvette 200 may be similar to cuvette 100, shown in FIG. 1. Cuvette 200 includes a body 205 which may include a front portion and a back portion, such as first body portion 105 and second body portion 110, both shown in FIG. 1. Body 205 may include a window 220 in which one or more electromagnetic blockers, similar to first electromagnetic blocker 140 and second electro magnetic blocker 150, both shown in FIG. 1, may be installed. Body 205 may further include a hinge 215 which allows cuvette 200 to open and close as desired. Body 205 may also include a finger recess 225 which allows a user to easily attach and disconnect clip 230 and separate body 205. Body 205 may further include one or more clip alignment elements 235 which serve to align or nudge a first body portion 105 and second body portion 110 together to ensure a solid connection is made by clip 230 to ensure that cuvette 200 is closed and will not leak.

Cuvette 200 may be used in conjunction with a spectroscope or a spectrograph. For example, a user may provide a liquid sample which may be contained within cuvette 200. In many embodiments, the liquid sample may be a sample of bodily fluid. Bodily fluids are known to those in the art but include fluids such as breast milk, blood, urine, saliva, spinal fluids, lymphatic fluids, and any other fluid contained in the human body. Other fluids may also be contained within cuvette 200 including those with chemical compositions, chemically dissolved solutions, and any other mineral, periodic element, or liquid that occurs in a liquid state. In the example of breast milk, cuvette 200 may contain the breast milk within cuvette 200 while cuvette 200 is inserted into a spectroscope or spectrograph for analysis. Cuvette 200 may be inserted into the spectroscope or spectrograph to the extent that at least the entirety of window 220 is contained within the spectroscope or spectrograph. The spectroscope or spectrograph may test the liquid sample by emitting electromagnetic energy in the form of light, visible and/or non-visible and determining the elements or composition of the liquid sample based on the reflectivity or permittivity of each element. Accordingly, these electromagnetic energy emissions travel through window 220 and through first slide 145, second slide 155, and second window 170 which are shown in FIG. 1. The spectroscope or spectrograph may then determine the elemental contents of the sample, whether they be periodic elements or whether they be compositional elements. In the case of a breast milk sample, for example, compositional elements may include identifying a percentage of fat, iron, and water within the breast milk instead of identifying a percentage of hydrogen, carbon, iron, and oxygen atoms within the breast milk. This analysis can be used to identify a nutritional content of the breast milk and may be the basis to formulating adequate nutrition for an infant child.

It is to be noted, however, that this is merely an example of one application for cuvette 200 and there are a host of different applications for cuvette 200 which are not limited to analyzing breast milk and may include veterinary purposes. Cuvette 200 could be used in place of any known prior art cuvette where it is desirable to reduce bubbles and prevent leakage for doing spectroscopic or spectrographic analysis of a liquid sample.

As shown in FIG. 2, cuvette 200 may further include a hole 240 which may be useful in hanging the cuvette by a wire during certain practical applications of examining a liquid sample.

FIG. 3 illustrates a perspective view of a cuvette 300 according to an embodiment of the present disclosure in a partially open condition. Cuvette 300 may be similar to cuvette 200 and cuvette 100 shown and described above with respect to FIG. 1 and FIG. 2, although cuvette 300 has a different form factor, as shown in FIG. 3.

Cuvette 300 includes a first body portion 305 and a second body portion 310. First body portion 305 includes a first hinge element 315, which couples with another element, such as a second hinge element 365 on second body portion 310 to form a hinge on cuvette 300. First hinge element 315 may be disposed at a bottom of cuvette 300, as shown in FIG. 3, although other implementations are possible. For example, corresponding hinge elements could be formed along respective sides of first body portion 305 and second body portion 310 such that a hinge is positioned parallel to a length of cuvette 300 instead of perpendicular to the length of cuvette 300, as shown in FIG. 3.

First body portion 305 may include a window 320 which includes a first electromagnetic blocker 340 which lets electromagnetic emissions pass from outside of cuvette 300 into a first slide 345 and a second slide 350. Window 320 may take any shape, although a generally oval shape is shown in FIG. 3. Generally speaking, window 320 is positioned in cuvette 300 to allow transmission of electromagnetic emissions through window 320 and into a liquid sample held in cuvette 300 for spectroscopy or spectrography of the liquid sample.

First body portion 305 may further include a finger recess 325 which abuts clip alignment element 330 to provide a user with an ergonomic interaction point for clipping and unclipping first body portion 305 from second body portion 310. Finger recess 325 and clip alignment element 330 are but one side of a clip which may retain cuvette 300 in a closed position.

First body portion 305 further includes a first slide retainer 335, which may be implemented as a shelf with a thickness approximately equal to a slide along with a recess in the shape of the slide that lets the slide rest in the recess. For example, first slide 345 may be installed and sit on first slide retainer 335 and, optionally, within a recess provided in first slide retainer 335. The recess for first slide 345 may be optionally provided in first body portion 305 which accepts at least a portion of a thickness of a slide below a surface of first body portion 305 such that at least some material of first body portion 305 extends above a thickness of first slide 345. In one embodiment, first slide retainer 335 may be positioned to hold a first slide 345 higher than second slide retainer 390 on second body portion 310, as will be discussed below, for the purpose of eliminating or popping air bubbles trapped between first slide 345 and second slide 350.

As previously mentioned, first body portion 305 may include a first electromagnetic blocker 340. First electromagnetic blocker 340 may be installed within window 320 of cuvette 300 and serve to block undesirable electromagnetic emissions from penetrating the sample and ensuring that transmission losses of desirable electromagnetic emissions are minimized through window 320. In essence, first electromagnetic blocker 340 may act as a filter which discriminates out undesirable electromagnetic emissions while allowing desirable electromagnetic emissions to pass through unimpeded. For example, first electromagnetic blocker 340 may be a high absorbance material, which blocks out light emissions from outside the cuvette while allowing light provided into window 320 to pass through into first slide 345 and second slide 355. In one embodiment, first electromagnetic blocker 340 may be selected from a material that has a high absorbance of electromagnetic emissions in the non-visible portion of the electromagnetic spectrum, such as ultraviolet light, infrared light, x-rays, gamma rays, and other similar lights. In an embodiment, first electromagnetic blocker 340 may be selected from a material that has a high absorbance of electromagnetic emission in the visible and non-visible portion of the electromagnetic spectrum. In another embodiment, first electromagnetic blocker 340 may be selected from a material that has high absorbance of electromagnetic emission in the visible portion of the electromagnetic spectrum. In another embodiment, first electromagnetic blocker 340 may be selected from a material that has a high absorbance of electromagnetic emission to wavelengths of light used by a spectroscope or a spectrograph. In practice, first electromagnetic blocker 340 may be fully seated within window 320 such that first slide 345 may be installed on first slide retainer 335 in first body portion 305.

First slide 345 and second slide 350 may be made from glass, or more preferably, quartz, for optimal transmission of light through first slide 345 and second slide 350. First slide 345 and second slide 350 may be as close to the same size as possible in terms of length and width, although second slide 350 may include a convex portion 355. In one embodiment, convex portion 355 of second slide 350 may provide a section of second slide 350 that is deeper than first slide 345. Convex portion 355 is particularly suitable for containing and maintaining liquid samples between first slide 345 and second slide 350. When first slide 345 and second slide 350 are installed together, convex portion 355 provides a gap where liquid can be contained without leaking from between slides. In other words, first slide 345 provides direct contact, without sample material, between first slide 345 and second slide 350 at virtually all portions of second slide 350 with the exception of convex portion 355, which forms a pocket of sorts to hold and maintain a liquid sample between first slide 345 and second slide 350, when first body portion 305 and second body portion 310 are closed together such that cuvette 300 is disposed in a closed position, as will be further discussed below.

Second body portion 310 may further include a window whereby a second electromagnetic blocker 360 may be installed in a manner similar to that described above with respect to first electromagnetic blocker 340 being installed in window 320 of first body portion 310. Second electromagnetic blocker 360 may be similar in implementation and description to first electromagnetic blocker 340, as discussed above.

Second body portion 310 may further include a second hinge element 365 that may interact with first hinge element 315 on first body portion 310. Second hinge element 365 may, for example, include a male element of a hinge while first hinge element 315 may include a female element of a hinge, or vice versa. Further, the embodiment of cuvette 300 shown in FIG. 3 is not limited to positioning first hinge element 315 and second hinge element 365 in a manner that is perpendicular to a length of cuvette 300. First hinge element 115 and second hinge element 365 may be positioned along a length of cuvette 300, parallel to the length of cuvette 300 and allow cuvette 300 to open along a lengthwise axis instead of a widthwise axis, as shown in FIG. 1, FIG. 3, and FIG. 4.

Second body portion 310 further includes a second slide support 390 which includes a shelf having a thickness that is approximately equal to or less than the thickness of slide 350 and includes a recess which allows slide 350 to be supported by second body portion 310 and held in a specific place in the recess by second body portion 310. It is noted that first slide support 335 and second slide support 390 may be disposed at different positions relative to a length of cuvette 300. In one embodiment, first slide support 335 may be positioned to be higher than second slide support 390 in order to cause first slide 345 and second slide 350 to be offset from each other when cuvette 300 is in a closed position. As first slide 345 comes into contact with second slide 350 during closing of cuvette 300, first slide 345 slides along slide 350 which prevents formation of air bubbles in a liquid sample and tends to pop existing air bubbles within the sample to increase an accuracy of a spectroscopic or spectrographic analysis.

Second body portion 310 further includes clip alignment elements 375 and 380 which may interface with, for example, clip alignment element 330 on first body portion 305, for example, which serve to nudge first body portion 305 and second body portion 310 into alignment and proper connection by clip 385. Clip 385 may include a friction type connection with clip alignment interface 330 or another portion of first body portion 305. As cuvette 300 is closed clip 385 may extend from second body portion 310 over first body portion 305 and clip by means of a tongue and groove joint, a friction joint, a mechanical interlock, or other joints known in the art to secure first body portion 305 to second body portion 310. Clip 385 may extend across first body portion 305 to finger recess 325 to allow a user to use finger recess 325 both for ensuring that cuvette 300 is closed and for providing a point of leverage to release a connection between clip 385 and first body portion 305, as desired.

Second body portion 310 in cuvette 300 may further include a hole 395 which may be useful in hanging the cuvette by a wire during certain practical applications of examining a liquid sample.

As shown in FIG. 3, cuvette 300 is disposed in a partially open condition to demonstrate, partially, a range of motion for cuvette 300 in opening and closing. It should be noted that first slide 345 and second slide 350 may be interchanged as desired and need not necessarily be associated with a particular one of first body portion 305 or second body portion 310. In practice, a liquid sample may be provided on second slide 350 when second body portion 310 is laying flat open, as shown in FIG. 4. Front body portion 305 may then be rotated by hinge elements 315 and 365 to close cuvette 300 and ensure that the liquid sample provided on second slide 350 remains in position on second slide 350 until cuvette 300 is closed.

FIG. 4 illustrates a perspective view of a cuvette 400 according to an embodiment of the present disclosure in a fully open condition. Cuvette 400 may be similar to cuvette 300, cuvette 200, and cuvette 100 shown and described above with respect to FIG. 1, FIG. 2, and FIG. 3, although cuvette 400 shares a similar form factor, to cuvette 300 shown in FIG. 3.

Cuvette 400 includes a first body portion 405 and a second body portion 410. First body portion 405 includes a first hinge element 415, which couples with another element, such as a second hinge element 465 on second body portion 410 to form a hinge on cuvette 400. First hinge element 415 may be disposed at a bottom of cuvette 400, as shown in FIG. 4 although other implementations are possible. For example, corresponding hinge elements could be formed along respective sides of first body portion 405 and second body portion 410 such that a hinge is positioned parallel to a length of cuvette 400 instead of perpendicular to the length of cuvette 400, as shown in FIG. 4.

First body portion 405 may include a window 420 which includes a first electromagnetic blocker 440 which lets electromagnetic emissions pass from outside of cuvette 400 into a first slide 445 and a second slide 450. Window 420 may take any shape, although a generally oval shape is shown in FIG. 4. Generally speaking, window 420 is positioned in cuvette 400 to allow transmission of electromagnetic emissions through window 420 and into a liquid sample held in cuvette 400 for spectroscopy or spectrography of the liquid sample.

First body portion 405 may further include a finger recess 425 which abuts clip alignment element 430 to provide a user with an ergonomic interaction point for clipping and unclipping first body portion 405 from second body portion 410. Finger recess 425 and clip alignment element 430 are but one side of a clip which may retain cuvette 400 in a closed position.

First body portion 405 further includes a first slide retainer 435, which may be implemented as a shelf with a thickness approximately equal to a slide along with a recess in the shape of the slide that lets the slide rest in the recess. For example, first slide 445 may be installed and sit on first slide retainer 435 and, optionally within a recess provided in first slide retainer 435. The recess for first slide 445 may be optionally provided in first body portion 405 which accepts at least a portion of a thickness of a slide below a surface of first body portion 405 such that at least some material of first body portion 405 extends above a thickness of first slide 445. In one embodiment, first slide retainer 435 may be positioned to hold a first slide 445 higher than second slide retainer 490 on second body portion 410, as will be discussed below, for the purpose of eliminating or popping air bubbles trapped between first slide 445 and second slide 450.

As previously mentioned, first body portion 405 may include a first electromagnetic blocker 440. First electromagnetic blocker 440 may be installed within window 420 of cuvette 400 and serve to block undesirable electromagnetic emissions from penetrating the sample and ensuring that transmission losses of desirable electromagnetic emissions are minimized through window 420. In essence, first electromagnetic blocker 440 may act as a filter which discriminates out undesirable electromagnetic emissions while allowing desirable electromagnetic emissions to pass through unimpeded. For example, first electromagnetic blocker 440 may be a high absorbance material, which blocks out light emissions from outside the cuvette while allowing light provided into window 420 to pass through into first slide 445 and second slide 455. In one embodiment, first electromagnetic blocker 440 may be selected from a material that has a high absorbance of electromagnetic emissions in the non-visible portion of the electromagnetic spectrum, such as ultraviolet light, infrared light, x-rays, gamma rays, and other similar lights. In an embodiment, first electromagnetic blocker 440 may be selected from a material that has a high absorbance of electromagnetic emission in the visible and non-visible portion of the electromagnetic spectrum. In another embodiment, first electromagnetic blocker 440 may be selected from a material that has high absorbance of electromagnetic emission in the visible portion of the electromagnetic spectrum. In another embodiment, first electromagnetic blocker 440 may be selected from a material that has a high absorbance of electromagnetic emission to wavelengths of light used by a spectroscope or a spectrograph. In practice, first electromagnetic blocker 440 may be fully seated within window 420 such that first slide 445 may be installed on first slide retainer 435 in first body portion 405.

First slide 445 and second slide 450 may be made from glass, or more preferably, quartz, for optimal transmission of light through first slide 445 and second slide 450. First slide 445 and second slide 450 may be as close to the same size as possible in terms of length and width, although second slide 450 may include a convex portion 455. In one embodiment, convex portion 455 of second slide 450 may provide a section of second slide 450 that is deeper than first slide 445. Convex portion 455 is particularly suitable for containing and maintaining liquid samples between first slide 445 and second slide 450. When first slide 445 and second slide 450 are installed together, convex portion 455 provides a gap where liquid can be contained without leaking from between slides. In other words, first slide 445 provides direct contact, without sample material, between first slide 445 and second slide 450 at virtually all portions of second slide 450 with the exception of convex portion 455, which forms a pocket of sorts to hold and maintain a liquid sample between first slide 445 and second slide 450, when first body portion 405 and second body portion 410 are closed together such that cuvette 400 is disposed in a closed position, as will be further discussed below.

Second body portion 410 may further include a window whereby a second electromagnetic blocker 460 may be installed in a manner similar to that described above with respect to first electromagnetic blocker 440 being installed in window 420 of first body portion 410. Second electromagnetic blocker 460 may be similar in implementation and description to first electromagnetic blocker 440, as discussed above.

Second body portion 410 may further include a second hinge element 465 that may interact with first hinge element 415 on first body portion 410. Second hinge element 465 may, for example, include a male element of a hinge while first hinge element 415 may include a female element of a hinge, or vice versa. Further, the embodiment of cuvette 400 shown in FIG. 4 is not limited to positioning first hinge element 415 and second hinge element 465 in a manner that is perpendicular to a length of cuvette 400. First hinge element 415 and second hinge element 465 may be positioned along a length of cuvette 400, parallel to the length of cuvette 400 and allow cuvette 400 to open along a lengthwise axis instead of a widthwise axis, as shown in FIG. 1, FIG. 3, and FIG. 4.

Second body portion 410 further includes a second slide support 490 which includes a shelf having a thickness that is approximately equal to or less than the thickness of slide 450 and includes a recess which allows slide 450 to be supported by second body portion 410 and held in a specific place in the recess by second body portion 410. It is noted that first slide support 435 and second slide support 490 may be disposed at different positions relative to a length of cuvette 400. In one embodiment, first slide support 435 may be positioned to be higher than second slide support 490 in order to cause first slide 445 and second slide 450 to be offset from each other when cuvette 400 is in a closed position. As first slide 445 comes into contact with second slide 450 during closing of cuvette 400, first slide 445 slides along slide 450 which prevents formation of air bubbles in a liquid sample and tends to pop existing air bubbles within the sample to increase an accuracy of a spectroscopic or spectrographic analysis.

Second body portion 410 further includes clip alignment elements 475 and 480 which may interface with, for example, clip alignment element 430 on first body portion 405, for example, which serve to nudge first body portion 405 and second body portion 410 into alignment and proper connection by clip 485. Clip 485 may include a friction type connection with clip alignment interface 430 or another portion of first body portion 405. As cuvette 400 is closed clip 485 may extend from second body portion 410 over first body portion 405 and clip by means of a tongue and groove joint, a friction joint, a mechanical interlock joint, or other joints known in the art to secure first body portion 405 to second body portion 410. Clip 485 may extend across first body portion 405 to finger recess 425 to allow a user to use finger recess 425 both for ensuring that cuvette 400 is closed and for providing a point of leverage to release a connection between clip 485 and first body portion 405, as desired.

Second body portion 410 in cuvette 400 may further include a hole 495 which may be useful in hanging the cuvette by a wire during certain practical applications of examining a liquid sample.

As shown in FIG. 4, cuvette 400 is disposed in a fully open condition to demonstrate a full range of motion for cuvette 400 in opening and closing between FIG. 2, FIG. 3, and FIG. 4. In practice, a liquid sample may be provided on second slide 450 when second body portion 410 lays flat open, as shown in FIG. 4. Front body portion 405 may then be rotated by hinge elements 415 and 465 to close cuvette 400 and ensure that the liquid sample provided on second slide 450 remains in position on second slide 450 until cuvette 400 is closed.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A cuvette, comprising:
a first body portion and a second body portion connected by a hinge;
a first slide; and
a second slide.

2. The cuvette of claim 1, wherein second slide includes a convex portion of the second slide.

3. The cuvette of claim 1, wherein the first slide is a flat slide.

4. The cuvette of claim 1, wherein the first slide is disposed on the first body portion.

5. The cuvette of claim 4, wherein the first body portion includes a first slide retainer.

6. The cuvette of claim 1, wherein the second slide is disposed on the second body portion.

7. The cuvette of claim 1, wherein the second body portion includes a second slide retainer.

8. The cuvette of claim 1, wherein he first body portion includes one hinge element of the hinge.

9. The cuvette of claim 8, wherein the second body portion includes a second hinge element of the hinge.

10. The cuvette of claim 1, wherein the first body portion includes a first window in the first body portion.

11. The cuvette of claim 10, further comprising an electromagnetic blocker installed in the first window.

12. The cuvette of claim 1, wherein the second body portion includes a second window in the second body portion.

13. The cuvette of claim 12, further comprising a second electromagnetic blocker installed in the second window.

14. The cuvette of claim 1, further comprising one or more aligning elements between the first body portion and the second body portion.

15. The cuvette of claim 1, further comprising a clip disposed on the second body portion.

16. The cuvette of claim 15, further comprising a clip retainer disposed on the first body portion.

17. The cuvette of claim 16, further comprising a finger recess that abuts the clip retainer on the first body portion.

18. The cuvette of claim 1, wherein the first slide and the second slide are formed from quartz.

19. The cuvette of claim 1, wherein the first slide and the second slide are formed from glass.

20. The cuvette of claim 1, further comprising one or more electromagnetic blockers installed in one or more of the first body portion and the second portion.
